(19) United States
(12) Patent Application Publication
(10) Pub. No.: US 2026/0175561 A1
(43) Pub. Date: Jun. 25, 2026

(54) METHOD FOR SETTING DRIVE SIGNAL, LIQUID EJECTION HEAD, AND IMAGE FORMING APPARATUS

(71) Applicant: KYOCERA CORPORATION, Kyoto-shi, Kyoto (JP)

(72) Inventor: Tomoaki TAKEMORI, Kirishima-shi, Kagoshima (JP)

(21) Appl. No.: 19/125,739

(22) PCT Filed: Mar. 4, 2024
(86) PCT No.: PCT/JP2024/008144

§ 371 Date: Apr. 30, 2025

(30) Foreign Application Priority Data
Mar. 13, 2023 (JP) 2023-038807

(51) Int. Cl. B41J 2/045; B41J 2/21

(52) U.S. Cl. CPC B41J 2/04508; B41J 2/04581; B41J 2/04588; B41J 2/0459; B41J 2/2114

(57) ABSTRACT

A method for setting a drive signal includes adjusting a voltage, mounting a liquid ejection head, and correcting the adjusted voltage. Adjusting the voltage includes adjusting the voltage of a drive signal for a liquid ejection head configured to eject a liquid to an adjusted voltage to cause an ejection result of a predetermined inspection liquid ejected from the liquid ejection head to be a predetermined reference result. Mounting the liquid ejection head includes mounting, after adjusting the voltage, the liquid ejection head on a liquid ejection recording apparatus. Correcting the adjusted voltage includes correcting, after mounting the liquid ejection head, the adjusted voltage to a corrected voltage using a correction value associated with an ejection liquid to be ejected from the liquid ejection head.

### TECHNICAL FIELD

The present invention relates to a method for setting a drive signal for a liquid ejection head, and a liquid ejection head and an image forming apparatus used with the method for setting a drive signal.

### BACKGROUND OF INVENTION

A liquid ejection recording apparatus such as an inkjet printer includes liquid ejection heads that eject inks for forming an image onto a recording medium. The recording medium that is a fabric sheet such as a woven fabric sheet or a knitted fabric sheet, or a plastic sheet may undergo treatment liquid application to fix the image formed on the recording media more stably. In this case, the liquid ejection recording apparatus further includes a liquid ejection head that ejects the treatment liquid.

The liquid ejection head includes a piezoelectric element, a liquid pressure chamber, and a liquid ejection orifice. The liquid ejection head displaces the piezoelectric element to apply pressure to a liquid filling the liquid pressure chamber to eject the liquid in the liquid pressure chamber through the liquid ejection orifice. The piezoelectric element is displaced in response to a pulsed drive signal indicating a voltage change.

Patent Literature 1 describes a liquid ejection head that ejects a liquid when driven with a drive voltage predetermined based on the viscosity characteristics of the liquid. Patent Literature 2 describes an inkjet head that undergoes drive voltage measurement in a shipping inspection of the inkjet head. The measured drive voltage is corrected based on the characteristics of the ink used for image recording. The waveform and the drive voltage after the voltage correction are set for the inkjet head. Patent Literature 2 also describes a print inspection using the corrected drive voltage for the inkjet head filled with an inspection ink.

### Citation List

### PATENT LITERATURE

Patent Literature 1: Japanese Unexamined Patent Application Publication No. 2005-144785

Patent Literature 2: Japanese Unexamined Patent Application Publication No. 2005-212475

### SUMMARY

In one aspect of the present disclosure, a method for setting a drive signal includes adjusting a voltage, mounting a liquid ejection head, and correcting the adjusted voltage. Adjusting the voltage includes adjusting the voltage of a drive signal for a liquid ejection head to an adjusted voltage to cause an ejection result of a predetermined inspection liquid ejected from the liquid ejection head to be a predetermined reference result. The liquid ejection head is configured to eject a liquid. Mounting the liquid ejection head includes mounting, after adjusting the voltage, the liquid ejection head on a liquid ejection recording apparatus. Correcting the adjusted voltage includes correcting, after mounting the liquid ejection head, the adjusted voltage to a corrected voltage using a correction value associated with an ejection liquid to be ejected from the liquid ejection head.

In another aspect of the present disclosure, a method for setting a drive signal includes mounting a liquid ejection head and correcting an adjusted voltage. Mounting the liquid ejection head includes mounting the liquid ejection head on a liquid ejection recording apparatus. The liquid ejection head is configured to eject an ejection liquid and is drivable with a drive signal having a voltage adjusted to the adjusted voltage to cause an ejection result of a predetermined inspection liquid ejected from the liquid ejection head to be a predetermined reference result. Correcting the adjusted voltage includes correcting, after mounting the liquid ejection head, the adjusted voltage to a corrected voltage using a correction value associated with an ejection liquid to be ejected from the liquid ejection head.

In another aspect of the present disclosure, a liquid ejection head for ejecting a liquid includes a storage storing a voltage for a drive signal to cause the liquid ejection head to eject a predetermined inspection liquid to produce a predetermined reference result.

In another aspect of the present disclosure, an image forming apparatus includes a liquid ejection head, a mount, a corrector, and an image former. The liquid ejection head is configured to eject a liquid. The liquid ejection head is drivable with a drive signal having a voltage adjusted to an adjusted voltage to cause an ejection result of a predetermined inspection liquid to be a predetermined reference result. The mount is a mount on which the liquid ejection head is mountable. The corrector corrects, for the drive signal for the liquid ejection head mounted on the mount, the adjusted voltage to a corrected voltage using a correction value associated with an ejection liquid to be ejected from the liquid ejection head. The image former forms an image on a recording medium with the ejection liquid ejected from the liquid ejection head driven with the corrected voltage.

In another aspect of the present disclosure, an image forming apparatus includes a liquid ejection head, a first mount, a second mount, a corrector, and an image former. The liquid ejection head is configured to eject a liquid. The liquid ejection head includes a storage storing an adjusted voltage for a drive signal to cause the liquid ejection head to eject a predetermined inspection liquid to produce a predetermined reference result. The liquid ejection head includes a first liquid ejection head and a second liquid ejection head. The first mount is a mount on which the first liquid ejection head is mountable. The second mount is a mount on which the second liquid ejection head is mountable. The adjusted voltage is a voltage of the drive signal causing a density of an image formed with the inspection liquid ejected on a medium from the liquid ejection head to match a density of an image formed on the medium with a predetermined reference amount of the inspection liquid. The reference amount is an amount of the inspection liquid ejected from the liquid ejection head driven with a standard drive signal to cause the liquid ejection head to eject an ink. The corrector corrects, after the second liquid ejection head is mounted on the second mount, a second adjusted voltage stored in a second storage included in the second liquid ejection head using a correction value associated with a treatment liquid to be ejected from the second liquid ejection head. The image former forms, after the second liquid ejection head is mounted on the second mount and the first liquid ejection head is mounted on the first mount, an image on a recording medium by causing the first liquid ejection head to eject the ink with the drive signal having a first adjusted voltage stored in a first storage included in the first liquid ejection head, and causing the second liquid ejection head to eject the treatment liquid with the drive signal having the second adjusted voltage corrected by the corrector. The correction value is a difference between a voltage of the drive signal to cause the second liquid ejection head to eject the target amount of the treatment liquid and a voltage of the drive signal to cause the second liquid ejection head to eject the target amount of the ink.

### BRIEF DESCRIPTION OF THE DRAWINGS

FIG. 1 is a perspective view of an image forming apparatus according to an embodiment of the present disclosure, illustrating its overall structure.

FIG. 2 is a schematic cross-sectional view taken along line II-II in FIG. 1.

FIG. 3 is an enlarged perspective view of a carriage illustrated in FIG. 1.

FIG. 4 is a diagram describing a drive signal for a liquid ejection head.

FIG. 5A is a diagram describing the principle of liquid ejection with the liquid ejection head.

FIG. 5B is a diagram describing the principle of liquid ejection with the liquid ejection head.

FIG. 5C is a diagram describing the principle of liquid ejection with the liquid ejection head.

FIG. 6 is a block diagram of the image forming apparatus according to the embodiment of the present disclosure, illustrating its electrical configuration.

FIG. 7 is a flowchart illustrating a method for setting a drive signal.

FIG. 8 is a graph used to determine a reference amount.

FIG. 9 is a graph showing an example of adjustment of a voltage of the drive signal for each of a first liquid ejection head and a second liquid ejection head different from the first liquid ejection head.

FIG. 10 is a graph used to determine a correction value.

FIG. 11 is a graph used to determine a correction value.

### DESCRIPTION OF EMBODIMENTS

Different liquid ejection heads have manufacturing differences and are driven with different voltages of drive signals. A liquid ejection head that has undergone inspection involves complicated operation for use. The liquid ejection head is mounted at a predetermined position to receive supply of a liquid expected to be ejected from the liquid ejection head in the inspection. In particular, a liquid ejection recording apparatus such as a color inkjet printer includes multiple liquid ejection head mounts. Each of the liquid ejection heads is to be mounted on a predetermined mount among the multiple mounts, further complicating the operation.

In one or more embodiments of the present disclosure, liquid ejection heads can be mounted without a complicated operation. The voltages of the drive signals for the liquid ejection heads can be adjusted to voltages appropriate for individual differences among the liquid ejection heads and ejection liquids ejected from the respective liquid ejection heads.

A method for setting a drive signal, a liquid ejection head, and an image forming apparatus according to one or more embodiments of the present disclosure will now be described with reference to the drawings. In one or more embodiments below, an inkjet printer (liquid ejection recording apparatus) including ink heads for ejecting inks for forming an image onto a wide and long recording medium, and treatment heads for ejecting a pretreatment liquid and a post-treatment liquid will be described as a specific example of the image forming apparatus. The inkjet printer may be used for digital textile printing to print images such as letters or patterns on a recording medium including a textile such as woven fabric or knitted fabric. In one or more embodiments of the present disclosure, the image forming apparatus is also used for printing various images on a recording medium such as a paper sheet or a resin sheet.

### Overall Structure of Inkjet Printer

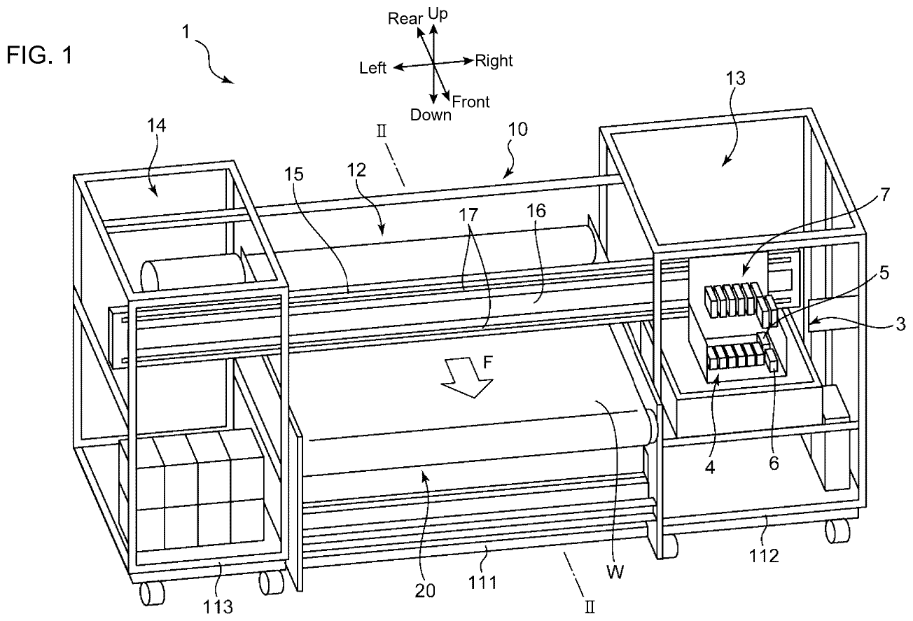

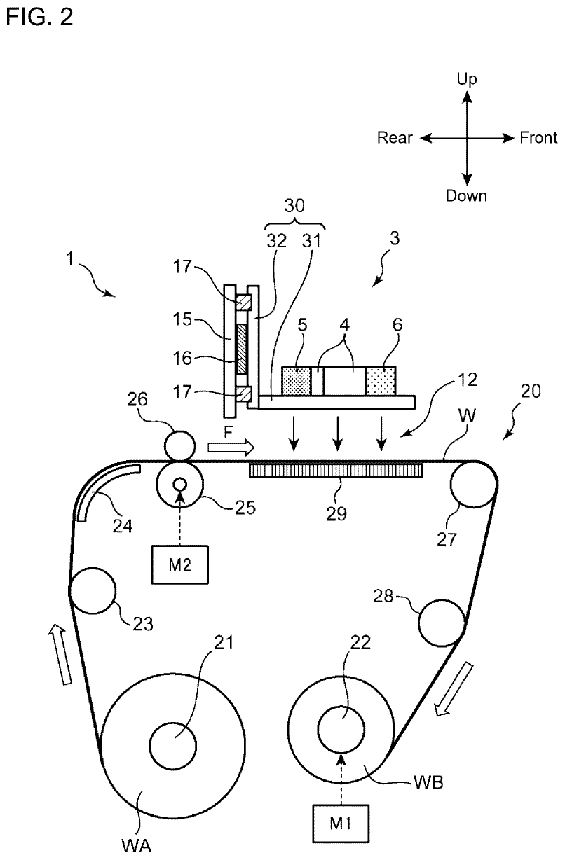

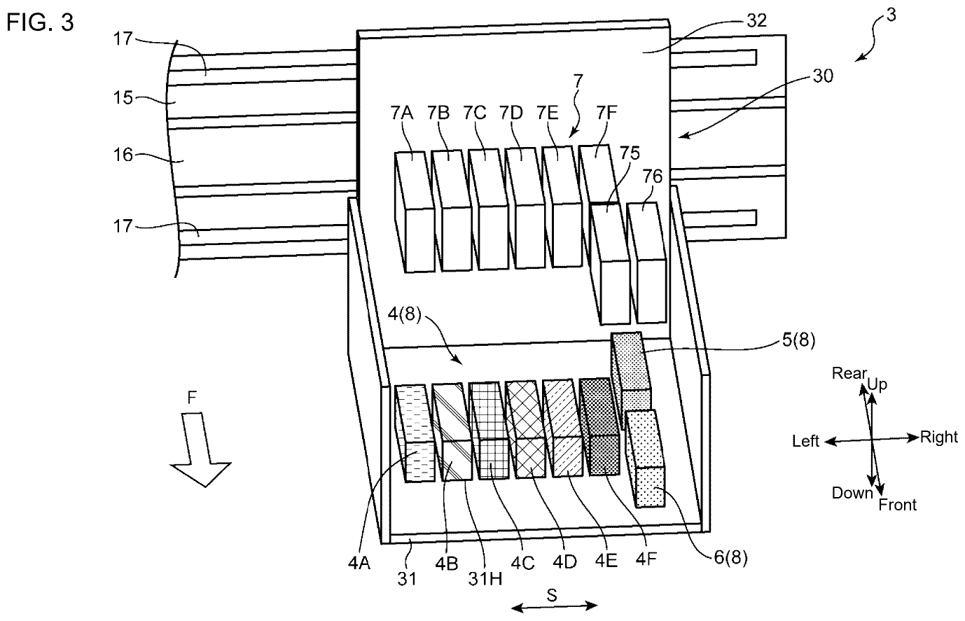

FIG. 1 is a perspective view of an inkjet printer 1 according to an embodiment of the present disclosure, illustrating its overall structure. FIG. 2 is a schematic cross-sectional view taken along line II-II in FIG. 1. The inkjet printer 1 is a printer for printing an image on a wide and long workpiece W (a recording medium or a medium) by inkjet printing. The inkjet printer 1 includes an apparatus frame 10, and a workpiece feeder 20 and a carriage 3 incorporated in the apparatus frame 10. Note that, in the present embodiment, a lateral direction is a main scanning direction S (FIG. 3) in printing on the workpiece W, and a direction from rear to front is a subscanning direction (a feed direction F of the workpiece W).

The apparatus frame 10 is a frame on which various components of the inkjet printer 1 are mounted. The workpiece feeder 20 is an assembly that intermittently feeds (transports) the workpiece W to allow the workpiece W to pass in the feed direction F from rear to front in a printing area in which an inkjet printing process is performed.

Multiple ink heads 4, a pretreatment head 5, a post-treatment head 6, and multiple subtanks 7 are mounted on the carriage 3. The carriage 3 reciprocates in the main scanning direction S (lateral direction) intersecting with the feed direction F of the workpiece W in the inkjet printing process.

The apparatus frame 10 includes a center frame 111, a right frame 112, and a left frame 113. The center frame 111 is a frame on which various components of the inkjet printer 1 are mounted and has a lateral width corresponding to the workpiece feeder 20. The right frame 112 stands on the right of the center frame 111, and the left frame 113 stands on the left of the center frame 111. A printing area 12 in which the inkjet printing process is performed on the workpiece W is defined between the right frame 112 and the left frame 113

The right frame 112 defines a maintenance area 13. The maintenance area 13 is an area into which the carriage 3 is retracted when the inkjet printing process described above is not performed. The maintenance area 13 is used for assembly and maintenance. The assembly includes mounting the multiple ink heads 4, the pretreatment head 5, the post-treatment head 6, and the multiple subtanks 7 on the carriage 3. The maintenance includes replacing the multiple ink heads 4, the pretreatment head 5, the post-treatment head 6, and the subtanks 7 mounted on the carriage 3.

The left frame 113 defines a turn-back area 14 for the carriage 3. The turn-back area 14 is an area for the carriage 3 that has scanned the printing area 12 from right to left in the inkjet printing process to enter temporarily before performing main scanning in the reverse direction.

The apparatus frame 10 receives, on its upper portion, a carriage guide 15 for guiding the carriage 3 to reciprocate in the lateral direction. The carriage guide 15 is a flat plate elongated in the lateral direction and is located above the workpiece feeder 20. The carriage guide 15 receives a timing belt 16 that is an endless belt in a manner rotatable in the lateral direction (the main scanning direction S).

The carriage guide 15 includes a pair of upper and lower guide rails 17 holding the carriage 3 in a manner reciprocable in the main scanning direction S. The pair of guide rails 17 extend parallel to each other in the lateral direction. The carriage 3 is engaged with the guide rails 17. The carriage 3 is fixed to the timing belt 16. The carriage 3, while being guided by the guide rails 17, moves in the left direction or in the right direction along the carriage guide 15 as the timing belt 16 rotates in the left direction or in the right direction.

FIG. 2 is now mainly referred to. The workpiece feeder 20 includes a feed roller 21 that unwinds the workpiece W before printing, and a take-up roller 22 that winds the workpiece W after printing. The feed roller 21 is located in a lower rear portion of the apparatus frame 10. The feed roller 21 is a winding shaft of a feed roll WA as a wound roll of the workpiece W before printing. The take-up roller 22 is located in a lower front portion of the apparatus frame 10. The take-up roller 22 is a winding shaft of a take-up roll WB as a wound roll of workpiece W after the inkjet printing process. The take-up roller 22 includes a first motor M1. The first motor M1 rotates the take-up roller 22 about its axis to wind the workpiece W.

A path extending through the printing area 12 between the feed roller 21 and the take-up roller 22 is a feed path of the workpiece W. This feed path includes, in the order from the upstream, a first tension roller 23, a workpiece guide 24, a transport roller 25 and a pinch roller 26, a turn roller 27, and a second tension roller 28. The first tension roller 23 applies a predetermined tension to the workpiece W upstream from the transport roller 25. The workpiece guide 24 redirects the workpiece W from upward to frontward and feeds the workpiece W into the printing area 12.

The transport roller 25 generates a feed force for feeding the workpiece W intermittently in the printing area 12. The transport roller 25 is driven by the second motor M2 to rotate about its axis. The transport roller 25 thus intermittently feeds the workpiece W frontward (in the predetermined feed direction F) to allow the workpiece W to pass through the printing area 12 (image formation position) facing the carriage 3. The pinch roller 26 faces the transport roller 25 from above. The pinch roller 26 thus forms a feed nip with the transport roller 25

The turn roller 27 redirects the workpiece W that has passed through the printing area 12 from frontward to downward. The turn roller 27 thus guides the workpiece W after the inkjet printing process to the take-up roller 22. The second tension roller 28 applies a predetermined tension to the workpiece W downstream from the transport roller 25. A platen 29 is located below the feed path of the workpiece W in the printing area 12.

The carriage 3 reciprocates, while being held by the guide rails 17 in a cantilevered manner, in the main scanning direction S (the lateral direction in the present embodiment) intersecting with (in the present embodiment, perpendicular to) the feed direction F in the printing area. The carriage 3 includes a carriage frame 30 as well as the multiple ink heads 4, the pretreatment head 5, the post-treatment head 6, and the multiple subtanks 7 mounted on the carriage frame 30. The carriage frame 30 includes a head support frame 31 and a back frame 32.

The head support frame 31 is a horizontal plate on which the multiple ink heads 4, the pretreatment head 5, and the post-treatment head 6 are mounted. The back frame 32 is a vertical plate extending upward from a rear edge of the head support frame 31. The timing belt 16 is fixed to the back frame 32. The guide rails 17 are engaged with the back frame 32.

### Details of Carriage

The carriage 3 will be described further. FIG. 3 is an enlarged perspective view of the carriage 3 illustrated in FIG. 1. In FIG. 3, the feed direction F (the subscanning direction) of the workpiece W and the main scanning direction S in which the carriage 3 moves are illustrated. In the example in FIG. 3, the carriage 3 receives the multiple ink heads 4 (first liquid ejection heads) for ejecting inks for forming an image onto the workpiece W, the pretreatment head 5 (second liquid ejection head) and the post-treatment head 6 (second liquid ejection head) for ejecting noncolor-developing treatment liquids, and the multiple subtanks 7 for supplying the inks and the treatment liquids to these liquid ejection heads.

The multiple ink heads 4 include first to sixth ink heads 4A to 4F for ejecting inks of six different colors. Examples include inks (second inks) each containing an aqueous solvent and a pigment. For example, the first ink head 4A ejects an orange ink, the second ink head 4B a green ink, the third ink head 4C a yellow ink, the fourth ink head 4D a red ink, the fifth ink head 4E a blue ink, and the sixth ink head 4F a black ink. The ink heads 4A to 4F for different colors are mounted on the head support frame 31 in the carriage 3 and arranged in the main scanning direction S.

The pretreatment head 5 and the post-treatment head 6 are mounted at positions different from the positions of the ink heads 4 in the feed direction F. The pretreatment head 5 is upstream from the ink heads 4 in the feed direction F. In FIG. 3, the single pretreatment head 5 is adjacent to the right end of an array of the ink heads 4. In the same or similar manner, the post-treatment head 6 is downstream from the ink heads 4 in the feed direction F. In FIG. 3, one post-treatment head 6 is adjacent to the right end of the array of the ink heads 4. In another embodiment, multiple pretreatment heads 5 or multiple post-treatment heads 6 may be mounted. In other words, at least one pretreatment head 5 and at least one post-treatment head 6 are mounted on the carriage 3.

The pretreatment head 5 ejects a pretreatment liquid for a predetermined pretreatment of the workpiece W to fix the inks ejected from the ink heads 4 on the workpiece W. The pretreatment liquid is ejected from the pretreatment head 5 to an area of the workpiece W on which no ink has been ejected from the ink heads 4. The pretreatment liquid is a noncolor-developing liquid that develops no color on the workpiece W. The pretreatment liquid is ejected before the inks are ejected. The pretreatment liquid thus improves, for example, fixation of the inks or agglomeration of ink pigments (dyes) on the workpiece W. Examples of such a pretreatment liquid include a treatment liquid of a solvent containing a bonding resin or a treatment liquid of a solvent containing a positively charged cationic resin.

The post-treatment head 6 ejects a post-treatment liquid for a predetermined post-treatment of the workpiece W to fix the inks ejected from the ink heads 4 on the workpiece W. The post-treatment liquid is ejected from the post-treatment head 6 to an area of the workpiece W on which the inks have been ejected from the ink heads 4. In the same or similar manner, the post-treatment liquid is a noncolor-developing liquid that develops no color on the workpiece W. The post-treatment liquid improves the fixation and toughness (durability against rubbing or scratching) of an ink image printed on the workpiece W by the ink heads 4. Examples of such a post-treatment liquid include a silicone treatment liquid. Note that the post-treatment liquid is different from the pretreatment liquid. More specifically, the post-treatment liquid and the pretreatment liquid contain different components.

The noncolor-developing treatment liquid refers to a liquid that is not perceptible as having developed a color to the naked eye when printed on the workpiece W alone. The color includes colors with zero saturation, such as black, white, and gray. Although the noncolor-developing treatment liquid is basically a transparent liquid, a liter of treatment liquid in a liquid state may appear slightly white or in another color. Such a faint color is not perceptible as having developed a color to the naked eye when printed on the workpiece W alone. Note that, although a type of treatment liquid printed alone on the workpiece W may cause a change such as adding gloss to the workpiece W, such a change is not referred to as developing a color.

The multiple subtanks 7 are supported by, with a holding frame (not illustrated), the carriage 3 above the multiple ink heads 4, the pretreatment head 5, and the post-treatment head 6. Each of the multiple subtanks 7 is located to correspond to one of the multiple ink heads 4, the pretreatment head 5, or the post-treatment head 6. The subtanks 7 receive supply of the respective inks or the respective treatment liquids from cartridges or main tanks (not illustrated) containing the inks and the treatment liquids. Each of the subtanks 7 supplies the supplied ink or treatment liquid to the corresponding one of the ink heads 4, the pretreatment head 5, or the post-treatment head 6. Each of the subtanks 7 is connected to the corresponding one of the ink heads 4, the pretreatment head 5, or the post-treatment head 6 with a channel (not illustrated).

More specifically, the multiple subtanks 7 include a first subtank 7A to a sixth subtank 7F, a pretreatment subtank 75, and a post-treatment subtank 76 arranged in the main scanning direction S in the rear.

The first subtank 7A located leftmost on the carriage 3 contains an orange ink. The first subtank 7A supplies the orange ink to the first ink head 4A. The orange ink is ejected from the first ink head 4A to the workpiece W. In the same or similar manner, the second subtank 7B supplies a green ink to the second ink head 4B. The other subtanks from the third subtank 7C to the sixth subtank 7F also have the same structure and function as, or similar structure and function to, the subtanks described above. The pretreatment subtank 75 supplies the pretreatment liquid to the pretreatment head 5. The post-treatment subtank 76 supplies the post-treatment liquid to the post-treatment head 6.

The above multiple ink heads 4, the pretreatment head 5, and the post-treatment head 6 are multiple liquid ejection heads 8 that have undergone an adjustment process. In other words, the heads that eject three different liquids have common specifications. Note that, in the adjustment process, a predetermined inspection liquid is supplied to each of the liquid ejection heads 8, and the voltage of the drive signal for the liquid ejection head 8 is adjusted to cause an ejection result of the inspection liquid ejected from the liquid ejection head 8 to be a predetermined reference result. The adjustment process will be described in detail later.

The head support frame 31 includes multiple openings 31H for mounting the multiple ink heads 4, the pretreatment head 5 and the post-treatment head 6. The liquid ejection heads 8 are fitted into the respective openings 31H to be mounted on the head support frame 31. After each of the liquid ejection heads 8 is mounted in one of the openings 31H in the head support frame 31, a correction process is further performed.

In the correction process, the voltage (hereafter referred to as an adjusted voltage) of the drive signal for each of the liquid ejection heads 8 adjusted in the adjustment process is corrected using a correction value associated with a liquid (hereafter referred to as an ejection liquid) to be ejected from the liquid ejection head 8 mounted in the corresponding opening 31H. The ejection liquid to be ejected from the liquid ejection head 8 mounted in the opening 31H is the ink or the treatment liquid supplied to the liquid ejection head 8 from the subtank 7 corresponding to the liquid ejection head 8.

In an example, one of the liquid ejection heads 8 that has undergone the adjustment process is mounted in the opening 31H for mounting the first ink head 4A. In this case, in the correction process, the adjusted voltage of the liquid ejection head 8 is corrected using the correction value associated with the orange ink to be ejected from the first ink head 4A. This allows the first ink head 4A that ejects the orange ink to be driven with the drive signal having the voltage corrected in the correction process (hereafter referred to as a corrected voltage). Other liquid ejection heads 8 undergo the same or a similar process to be the second to sixth ink heads 4B to 4F.

In another example, another liquid ejection head 8 (second liquid ejection head) that has undergone the adjustment process is mounted in the opening 31H for mounting the pretreatment head 5. In this case, in the correction process, the adjusted voltage (second adjusted voltage) of the liquid ejection head 8 is corrected using the correction value associated with the pretreatment liquid to be ejected from the pretreatment head 5. This allows the pretreatment head 5 that ejects the pretreatment liquid to be driven with the drive signal having the adjusted voltage corrected in the correction process. Another liquid ejection head 8 undergoes the same or a similar process to be the post-treatment head 6.

In other words, the liquid ejection heads 8 are configured to eject various liquids, such as inks of multiple colors, the pretreatment liquid, and the post-treatment liquid, suppliable after mounting of the liquid ejection heads 8 in the inkjet printer 1.

As described above, the inkjet printer 1 according to the present embodiment is an all-in-one printer including three types of heads, or the ink heads 4, the pretreatment head 5, and the post-treatment head 6, mounted on the single carriage 3. This inkjet printer 1 can perform a process of ejecting the pretreatment liquid and a process of ejecting the post-treatment liquid integrally in, for example, a printing process of inkjet printing on a textile in digital textile printing. This can simplify the textile printing process, and can downsize textile printing apparatuses.

### Principle of Liquid Ejection with Liquid Ejection Head

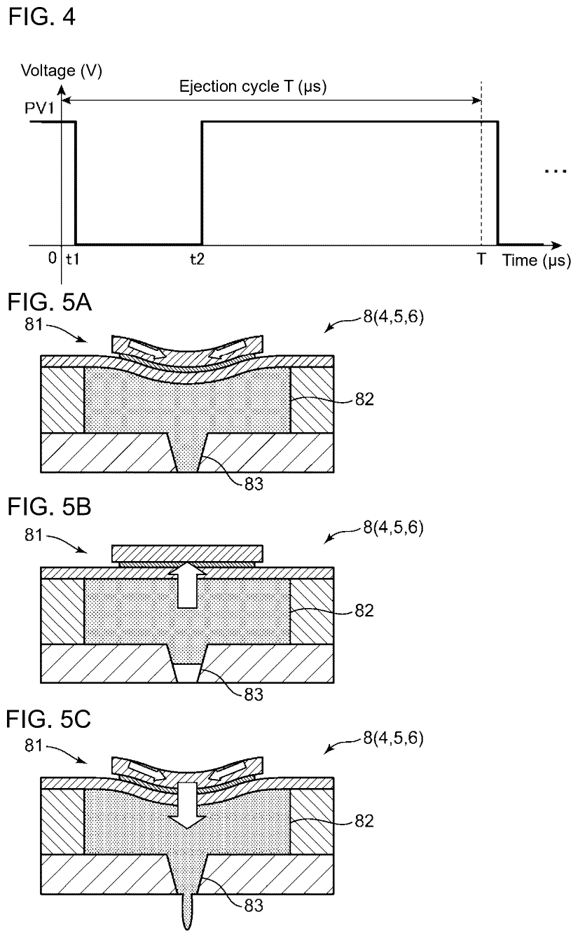

The principle of liquid ejection with the liquid ejection heads 8 will now be described. FIG. 4 is a diagram describing the drive signal for each of the liquid ejection heads 8. FIGS. 5A, 5B and 5C are diagrams describing the principle of liquid ejection with the liquid ejection heads 8. As illustrated in FIGS. 5A, 5B, and 5C, each of the liquid ejection heads 8 includes a piezoelectric element 81, a liquid pressure chamber 82 to be filled with a liquid supplied from the subtank 7 through a channel (not illustrated), and a nozzle 83 for ejecting the liquid in the liquid pressure chamber 82.

The drive signal for each of the liquid ejection heads 8 is a pulsed square wave that varies periodically in predetermined ejection cycles (ejection intervals) T, as illustrated in FIG. 4. The amplitude of the drive signal for each of the liquid ejection head 8 indicates the voltage to be applied to the corresponding piezoelectric element 81 in the liquid ejection head 8.

Upon the start of driving the liquid ejection head 8 with the drive signal in FIG. 4, a voltage PV1 applied to the piezoelectric element 81 at the end of the previous ejection cycle T is continuously applied to the piezoelectric element 81 from time 0 to time t1. This allows the piezoelectric element 81 to remain deformed for a predetermined period as illustrated in FIG. 5A. The liquid in the liquid pressure chamber 82 is thus under constant pressure and fills the nozzle 83.

Then, from time t1 to time t2 (FIG. 4), the amplitude of the drive signal is zero with no voltage applied to the piezoelectric element 81. As illustrated in FIG. 5B, this releases the deformation of the piezoelectric element 81, causing the piezoelectric element 81 to be parallel to the upper surface of the liquid pressure chamber 82. The pressure applied on the liquid in the liquid pressure chamber 82 is thus reduced, causing a portion of the liquid in the nozzle 83 to fill the liquid pressure chamber 82.

Then, from time t2 to time T (FIG. 4), the voltage PV1 is applied again to the piezoelectric element 81. As illustrated in FIG. 5C, this deforms the piezoelectric element 81 and applies pressure to the liquid in the liquid pressure chamber 82, causing the liquid in the liquid pressure chamber 82 to be ejected through the nozzle 83. Hereafter, the total amount of liquid ejected through the nozzle 83 during a single ejection cycle T is referred to as an ejection amount of the liquid.

The same drive signal causes the liquid ejection heads 8 to eject different ejection amounts of liquids based on the physical properties of the liquids ejected from the liquid ejection heads 8. The physical properties of the liquids include components of the liquid (e.g., dyes, pigments, coloring agents, and resins), viscosity, and surface tension. Additionally, the piezoelectric elements 81, the liquid pressure chambers 82, and the nozzles 83 included in the liquid ejection heads 8 have individual differences. The ejection amounts of liquids ejected from the liquid ejection heads 8 thus vary based on these individual differences as well.

The adjustment process is thus performed, before the liquid ejection heads 8 are mounted on the head support frame 31 (FIG. 3), to adjust the voltage of the drive signals for the liquid ejection heads 8 to adjusted voltages based on the individual differences between the liquid ejection heads 8. After the liquid ejection heads 8 that have undergone the adjustment process are mounted on the head support frame 31 (FIG. 3), the correction process is further performed to correct the voltage of the drive signals for the liquid ejection heads 8 based on the ejection liquids to be ejected from the respective liquid ejection heads 8. This allows each of the ink heads 4, the pretreatment head 5, and the post-treatment head 6 as the liquid ejection heads 8 to be driven with the drive signal having the corrected voltage and eject an appropriate amount of liquid. The adjustment process and the correction processes will be described in detail later.

### Electrical Configuration of Inkjet Printer

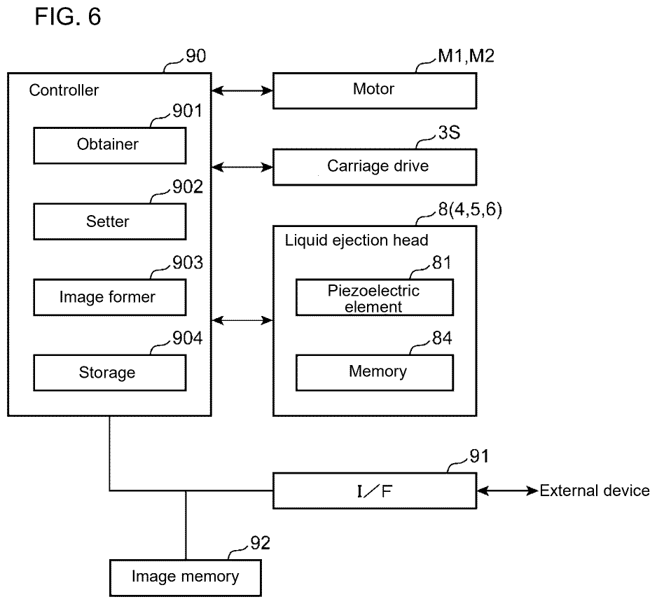

The electrical configuration of the inkjet printer 1 according to the present embodiment will now be described. FIG. 6 is a block diagram of the inkjet printer 1 according to the present embodiment, illustrating its electrical configuration. The inkjet printer 1 includes a controller 90 for centrally controlling the operations of components of the inkjet printer 1, the first motor M1, the second motor M2, a carriage drive 3S, the multiple liquid ejection heads 8 (the ink heads 4, the pretreatment head 5, and the post-treatment head 6), an interface circuit 91 (hereafter referred to as I/F 91), and an image memory 92.

The controller 90 includes, for example, a central processing unit (CPU), a read-only memory (ROM) for storing a control program, and a random-access memory (RAM) used as a work area for the CPU. In addition to the first motor M1 and second motor M2 described above, the carriage drive 3S, the multiple liquid ejection heads 8 (the multiple ink heads 4, the pretreatment head 5, and the post-treatment head 6), the I/F 91 and the image memory 92 are electrically connected to the controller 90, for example.

The carriage drive 3S includes, for example, a motor (not illustrated) for rotating the timing belt 16 to cause the carriage 3 to reciprocate in the main scanning direction S.

Each of the multiple liquid ejection heads 8 (the multiple ink heads 4, the pretreatment head 5, and the post-treatment head 6) includes a memory 84 (storage) in addition to the piezoelectric element 81 described above. The memory 84 in the liquid ejection head 8 prestores the adjusted voltage for the liquid ejection head 8 adjusted in the adjustment process.

The image memory 92 temporarily stores image data for printing transmitted from, for example, an external device such as a personal computer.

The I/F 91 is an interface circuit to allow data communication with the external device. The I/F 91 generates a communication signal based on a communication protocol of a network connecting, for example, the inkjet printer 1 and the external device. The I/F 91 also converts a communication signal transmitted from the network to data in a format processable with the inkjet printer 1. The controller 90 receives a print instruction signal transmitted from, for example, a personal computer through the I/F 91. The image memory 92 stores the image data transmitted from, for example, a personal computer through the I/F 91.

The controller 90 causes the CPU to execute the control program stored in the ROM to function as an obtainer 901, a setter 902, an image former 903, and a storage 904.

The obtainer 901 obtains the adjusted voltage stored in the memory 84 in each of the liquid ejection heads 8 in the correction process performed after the liquid ejection head 8 undergoes the adjustment process and then is mounted in the corresponding opening 31H in the head support frame 31 (FIG. 3). Each of the liquid ejection heads 8 mounted in the openings 31H in the head support frame 31 (FIG. 3) is hereafter referred to as a mounted head.

The setter 902 corrects, using the correction value associated with the ink to be ejected from the mounted head, the adjusted voltage (a first adjusted voltage) obtained by the obtainer 901 from the memory 84 (a first storage) in the mounted head mounted in the opening 31H (a first mount) for mounting the ink head 4 (the first liquid ejection head). The setter 902 sets the corrected voltage after correction as the voltage of the drive signal for the mounted head.

In the same or similar manner, the setter 902 corrects the adjusted voltage (the second adjusted voltage) obtained by the obtainer 901 from the memory 84 (a second storage) in the mounted head mounted in the opening 31H (a second mount) for mounting the pretreatment head 5, using the correction value associated with the treatment liquid to be ejected from the mounted head. The setter 902 sets the corrected voltage after correction as the voltage of the drive signal for the mounted head.

The setter 902 also corrects the adjusted voltage obtained by the obtainer 901 from the memory 84 in the mounted head fit in the opening 31H for mounting the post-treatment head 6, using the correction value associated with the treatment liquid to be ejected from the mounted head. The setter 902 sets the corrected voltage after correction as the voltage of the drive signal for the mounted head.

The image former 903 supplies a predetermined liquid to each of the multiple mounted heads (the multiple ink heads 4, the pretreatment head 5, and the post-treatment head 6) and drives each of the multiple mounted heads with the corrected voltage set by the setter 902. This allows the image former 903 to form an image on the workpiece W with the ejection liquids ejected from the respective mounted heads.

More specifically, the image former 903 forms the image on the workpiece W by causing the pretreatment head 5 to eject the pretreatment liquid and the post-treatment head 6 to eject the post-treatment liquid with the drive signals with the corrected voltages set by the setter 902 while causing each of the ink heads 4 to eject a predetermined ink with the drive signal having the corrected voltage set by the setter 902.

The storage 904 prestores, for example, various thresholds and parameters to be referred to by the obtainer 901, the setter 902, and the image former 903.

More specifically, the storage 904 prestores, in a manner associated with one another, the position of each of the openings 31H (FIG. 3) in the head support frame 31 (FIG. 3), the ejection liquid to be ejected from each of the liquid ejection heads 8 mounted in the opening 31H at the corresponding position, and the correction value for correcting the adjusted voltage of each of the liquid ejection heads 8.

For example, the storage 904 prestores, in a manner associated with one another, a position Left 1 that is the position of the opening 31H (FIG. 3) located leftmost in the head support frame 31 (FIG. 3), the orange ink to be ejected from the first ink head 4A mounted in the opening 31H at the position, and the correction value for correcting the adjusted voltage for the first ink head 4A.

Note that the structure of the controller 90 is not limited to the example described in the above embodiment, and may have a different structure based on the structures of the apparatus and programs. In other words, the controller 90 can implement the functions of the obtainer 901, the setter 902, and the image former 903 described above.

### Method for Setting Drive Signal for Liquid Ejection Head

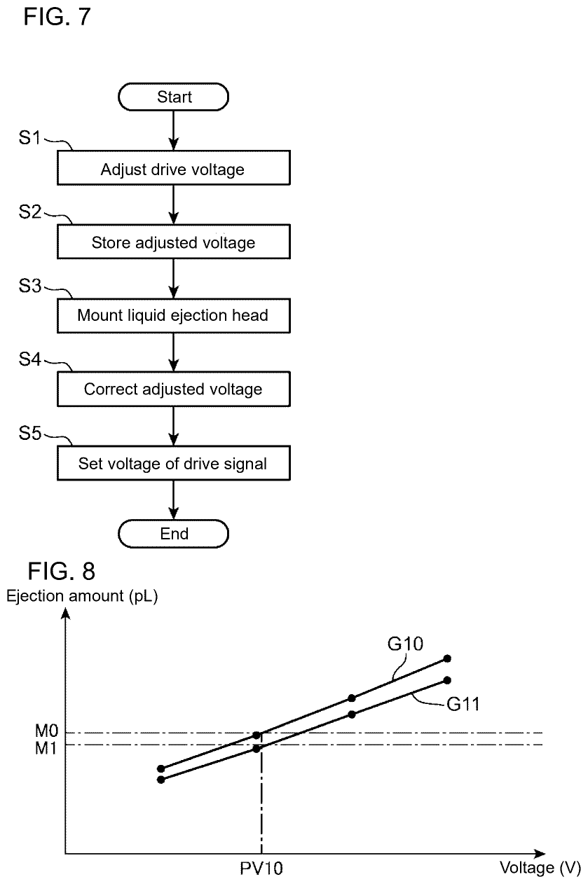

The method for setting drive signals for the liquid ejection heads 8 will now be described. The method for setting drive signals for the liquid ejection heads 8 is a method for setting a drive signal for each of the liquid ejection heads 8. The drive signal set with the method for setting the drive signal is used at the time of, for example, liquid ejection recording. At the time of liquid ejection recording refers to a time when the liquid ejection head 8 ejects the liquid onto the workpiece W to form an image on the workpiece W. FIG. 7 is a flowchart illustrating the method for setting the drive signal.

In the method for setting the drive signal, the liquid ejection head 8 after manufacturing first undergoes the adjustment process at any time before the liquid ejection head 8 is mounted in one of the multiple openings 31H (FIG. 3) in the head support frame 31 (FIG. 3). The adjustment process adjusts (calibrates) the voltage of the drive signal for the liquid ejection head 8 based on its individual difference. The adjustment process includes step S1 and step S2 in FIG. 7.

In Step S1, the predetermined inspection liquid is supplied to the liquid pressure chamber 82 (FIG. 5A) in the liquid ejection head 8, and the voltage of the drive signal for the liquid ejection head 8 is adjusted to cause the ejection result of the inspection liquid ejected from the liquid ejection head 8 per ejection cycle T (FIG. 4) to be the predetermined reference result.

The inspection liquid may be an ink (first ink) containing an aqueous solvent and a dye, which is different from the ejection liquid (an ink, the pretreatment liquid, or the post-treatment liquid) to be ejected from the liquid ejection head 8. Examples of the solvent include propylene glycol and surfactants. Examples of the dye include a dye that is unlikely to react (e.g., agglomerate) with the treatment liquids (the pretreatment liquid or the post-treatment liquid) to be ejected from the liquid ejection head 8. For example, brilliant blue FCF or Blue 1 (cyan) may be used as a dye. Note that the viscosity of the inspection liquid may be adjusted by adjusting the ratio of solvent to water contained in the inspection liquid. The inspection liquid may also contain a preservative.

Step S1 is performed automatically when an inspection device executes a control program prestored in the inspection device after an operator mounts the liquid ejection head 8 on a predetermined mount in the inspection device. However, step S1 is not limited to this example. The operator may operate the inspection device to cause step S1 to be performed semi-automatically after mounting the liquid ejection head 8 on the predetermined mount in the inspection device. Step S1 will be described in detail later.

In step S2, the memory 84 in the liquid ejection head 8 stores the adjusted voltage that is the voltage of the drive signal for the liquid ejection head 8 resulting from adjustment in step S1. Step S2 is performed automatically by the inspection device used in step S1. However, step S2 is not limited to this example, and may be performed manually by the operator using a dedicated jig for writing data into the memory 84.

After the adjustment process ends, step S3 (a mounting process) and the correction process are performed. The correction process corrects, based on the liquid to be ejected from the liquid ejection head 8, the adjusted voltage of the liquid ejection head 8 adjusted in the adjustment process. The correction process includes step S4 and step S5 illustrated in FIG. 7.

In step S3, the liquid ejection head 8 after the adjustment process is mounted in one of the multiple openings 31H in the head support frame 31 (FIG. 3). Step S3 may be performed manually by the operator, or may be performed automatically using, for example, a work robot. Hereafter, the liquid ejection head 8 mounted in one of the openings 31H in step S3 and to be a target of the correction process is referred to as a target head.

In step S4, the adjusted voltage that is the voltage of the drive signal for the target head after adjustment in step S1 is corrected using the correction value associated with the ejection liquid to be ejected from the target head.

More specifically, in step S4, the obtainer 901 (FIG. 6) obtains, from the memory 84 in the target head, the adjusted voltage for the target head adjusted in step S1. The setter 902 (FIG. 6) corrects the adjusted voltage obtained by the obtainer 901 using the correction value associated with the ejection liquid to be ejected from the target head. As described above, the correction value associated with the ejection liquid to be ejected from the target head is prestored in the storage 904 in a manner associated with the position of the opening 31H in which the target head is mounted. Step S4 will be described in detail later.

In step S5, the setter 902 (FIG. 6) sets the corrected voltage that is the voltage after correction in step S4 as the voltage of the drive signal for the liquid ejection head 8 at the time of liquid ejection recording.

With this method for setting the drive signal, the voltage of the drive signal for the liquid ejection head 8 is adjusted in the adjustment process to cause the ejection result of the inspection liquid ejected from the liquid ejection head 8 to be the predetermined reference result. In the correction process after the adjustment process, the adjusted voltage, or voltage of the drive signal for the liquid ejection head 8 adjusted in the adjustment process, is further adjusted to the corrected voltage corrected using the correction value associated with the ejection liquid to be ejected from the liquid ejection head 8. Thus, this method for setting the drive signal can adjust the voltage of the drive signal for the liquid ejection head 8 after mounted in the opening 31H to a voltage appropriate for the individual difference of the liquid ejection head 8 and for the liquid to be ejected from the liquid ejection head 8.

In contrast, the voltage of the drive signal for the liquid ejection head 8 may be adjusted to a voltage based on the individual difference of the liquid ejection head 8 and the liquid to be ejected from the liquid ejection head 8 before the liquid ejection head 8 is mounted in a predetermined opening 31H. In this case, the liquid ejection head 8 is to be mounted accurately in the predetermined opening 31H to appropriately receive supply of the same type of liquid as the liquid used in the adjustment. This involves a complicated operation.

However, with this method for setting the drive signal, the adjusted voltage for the liquid ejection head 8 is corrected to be the corrected voltage appropriate for the liquid to be ejected from the liquid ejection head 8 after the liquid ejection head 8 is mounted in the opening 31H. This allows, without a complicated operation as described above, the liquid ejection head 8 after the adjustment process to be mounted in any one of the openings 31H in the inkjet printer 1 to appropriately receive supply of the liquid to be ejected from the liquid ejection head 8 mounted in the opening 31H.

Thus, the image former 903 can form an image with appropriate density on the workpiece W using appropriate amounts of ejection liquids ejected from the ink heads 4, the pretreatment head 5, and the post-treatment head 6 that are the liquid ejection heads 8.

The inspection liquid supplied to the liquid ejection head 8 in the adjustment process is an ink containing a dye. Each of the liquids ejected from the ink heads 4, the pretreatment head 5, and the post-treatment head 6 that are the liquid ejection heads 8 after the adjustment process is an ink containing a pigment or a treatment liquid for fixing the ink containing a pigment on the workpiece W. The inspection liquid supplied in the adjustment process and remaining in the liquid ejection head 8 can thus be easily washed away. This reduces the likelihood of the ink or the treatment liquid ejected from each of the ink heads 4, the pretreatment head 5, and the post-treatment head 6 that are the liquid ejection heads 8 mixes with the remaining inspection liquid and agglomerates.

The liquid ejection head 8 includes the memory 84 storing the voltage of the drive signal for causing the liquid ejection head 8 to eject the inspection liquid to produce the predetermined reference result. Thus, the voltage of the drive signal for the liquid ejection head 8 can be adjusted to a voltage appropriate for the liquid to be ejected from the liquid ejection head 8 in the correction process after the liquid ejection head 8 that has undergone the adjustment process is mounted in any one of the openings 31H in the inkjet printer 1. This allows mass-manufacturing of the liquid ejection head 8 as a common component mountable on any mount included in a liquid ejection recording apparatus, such as the inkjet printer 1, used with the method for setting the drive signal described above.

Note that the correction process for the target liquid ejection head 8 mounted in one of the openings 31H after the adjustment process is repeated multiple times for each of the multiple ink heads 4, the pretreatment head 5, and the post-treatment head 6 included in the inkjet printer 1.

However, the adjustment process may be performed for the multiple liquid ejection heads 8 that are the multiple ink heads 4, the pretreatment head 5, and the post-treatment head 6 included in the inkjet printer 1. The multiple liquid ejection heads 8 that have undergone the adjustment process may then be mounted in the multiple openings 31H and undergo the correction process.

In other words, a manufacturer of the inkjet printer 1 can purchase the multiple liquid ejection heads 8 that have undergone the adjustment process, mount the multiple liquid ejection heads 8 in the inkjet printer 1 under manufacturing, and perform the correction process for each of the multiple liquid ejection heads 8 that are the multiple ink heads 4, the pretreatment head 5, and the post-treatment head 6 in the inkjet printer 1.

The memory 84 in each of the liquid ejection head 8 may prestore identification information of the liquid ejection head 8. In this case, in step S2, the controller 90 may cause the storage 904 (FIG. 6) or a storage in an external device that can communicate through the I/F 91 (FIG. 6) to store, in a manner associated with the identification information of the liquid ejection head 8, the adjusted voltage that is the voltage of the drive signal for the liquid ejection head 8 after adjustment in step S1. Then, in step S4, the obtainer 901 (FIG. 6) may obtain, from the storage 904 (FIG. 6) or the storage in the external device, the adjusted voltage for the target head associated with the identification information of the target head.

When the inspection liquid remaining in the liquid ejection head 8 is washed after step S2 and before step S3, the ejection liquid to be ejected from the liquid ejection head 8 may be filled into the liquid ejection head 8.

### Details of Step S1

The method for adjusting the voltage of the drive signal for the liquid ejection head 8 in step S1 (FIG. 7) will now be described in detail. In step S1, the voltage of the drive signal for the liquid ejection head 8 is adjusted to cause the ejection result of the inspection liquid ejected from the liquid ejection head 8 to be the predetermined reference result. In the present embodiment, the reference result is a result indicating the ejection amount of the inspection liquid being a predetermined reference amount. More specifically, operations 1 to 4 described below are performed in step S1 in this case.

In operation 1, the inspection liquid is supplied to the liquid ejection head 8 that is a target of the adjustment process (hereafter referred to as an inspection target head).

In operation 2, the inspection target head is driven, with the drive signal having a predetermined waveform and a voltage typically used for ejecting an ink, to cause the inspection liquid to be ejected onto the workpiece W.

In operation 3, the density (optical density or OD) of the image formed on the workpiece W with the inspection liquid ejected from the inspection target head in operation 2 is measured.

In operation 4, the density measured in operation 3 is compared with the density of an image formed on the workpiece W with the predetermined reference amount of the inspection liquid (hereafter referred to as a reference density). Operations 2 to 4 are repeated while increasing or decreasing the voltage of the drive signal used in operation 2 until the density measured in operation 3 matches the reference density. The reference density may be predetermined based on experimental values. The density measured in operation 3 matching the reference density refers to the density measured in operation 3 matching the reference density within a predetermined error range.

When the density measured in operation 3 matches the reference density in operation 4, step S1 ends, and step S2 (FIG. 7) is performed. This causes the memory 84 to store, as the adjusted voltage, the voltage of the drive signal used in the operation 2 most recently performed when step S1 ends.

Thus, step S1 allows more accurate determination that the ejection amount of the inspection liquid satisfies the predetermined reference amount based on the density of the image actually formed on the workpiece W with the inspection liquid, rather than numerical estimates.

Note that the reference amount used in operation 4 may be determined as an ejection amount of the inspection liquid ejected from the liquid ejection head 8 driven with the drive signal for causing the liquid ejection head 8 to eject a predetermined target amount of a standard ejection liquid (hereafter referred to as a standard drive signal). The standard ejection liquid is an ink typically used for the inkjet printer 1, such as a black ink. The target amount may be determined as, for example, an amount at which the standard ejection liquid ejected from the liquid ejection head 8 forms an image having a density that does not cause discomfort, such as an excess thickness or thinness, to a user of the inkjet printer 1.

FIG. 8 is a graph used to determine the reference amount. A line G10 in FIG. 8 indicates the relationship between the voltage of the drive signal for the liquid ejection head 8 (the horizontal axis) and the ejection amount of the standard ejection liquid ejected from the liquid ejection head 8 driven with the drive signal having the voltage (the vertical axis). A line G11 in FIG. 8 indicates the relationship between the voltage of the drive signal for the liquid ejection head 8 (the horizontal axis) and the ejection amount of the inspection liquid ejected from the liquid ejection head 8 driven with the drive signal having the voltage (the vertical axis). The lines G10 and G11 in FIG. 8 may be derived from experimental values.

For example, the standard drive signal may be determined, using the graph in FIG. 8, as a drive signal having a voltage PV10 with which the liquid ejection head 8 ejects a target amount M0 (e.g., 18 pl) of the standard ejection liquid. The predetermined reference amount may be determined as an ejection amount M1 (e.g. 17 pl) of the inspection liquid ejected from the liquid ejection head 8 driven with the standard drive signal.

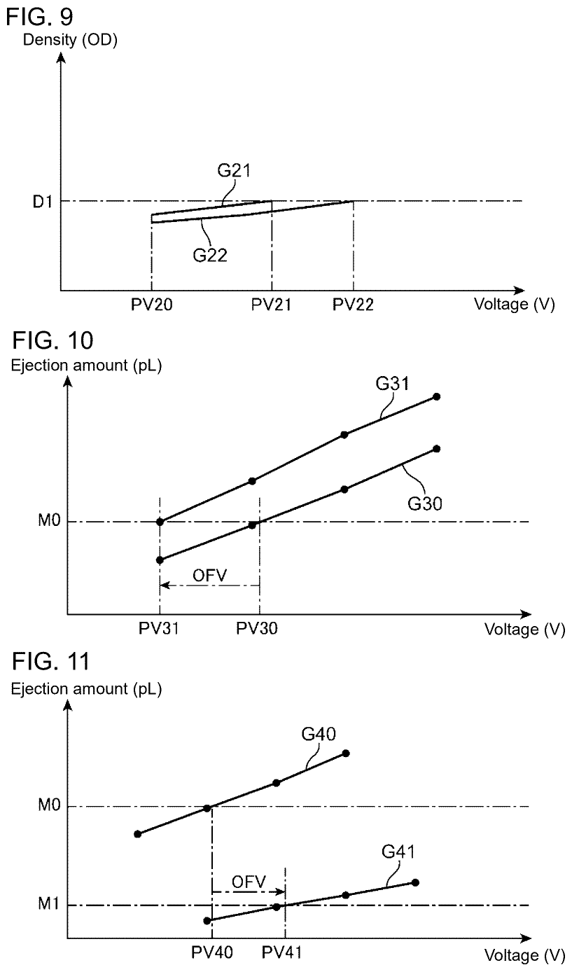

The density of the image formed with the reference amount M1 of the inspection liquid ejected onto the workpiece W is referred to as a reference density D1. FIG. 9 illustrates example adjustment of the voltage of the drive signal for each of a first liquid ejection head 8 and a second liquid ejection head 8 different from the first liquid ejection head 8 in step S1. In FIG. 9, the horizontal axis indicates the voltage of the drive signal used in operation 2, and the vertical axis indicates the density measured in operation 3.

In example adjustment indicated by a line G21 in FIG. 9, the inspection target head in step S1 is the first liquid ejection head 8. When the voltage of the drive signal used in operation 2 increases from a voltage PV20 to a voltage PV21, the density measured in operation 3 matches the reference density D1, causing step S1 to end. In this case, the voltage PV21 is stored into the memory 84 in the first liquid ejection head 8 in step S2.

In example adjustment indicated by a line G22 in FIG. 9, the inspection target head in step S1 is the second liquid ejection head 8 different from the first liquid ejection head 8. When the voltage of the drive signal used in operation 2 increases from the voltage PV20 to a voltage PV22, the density measured in operation 3 matches the reference density D1, causing step S1 to end. In this case, the voltage PV22 is stored into the memory 84 in the second liquid ejection head 8 in step S2.

As described above, the reference amount may be determined as the ejection amount (e.g. 17 pl) of the inspection liquid ejected from the liquid ejection head 8 driven with the standard drive signal for causing the liquid ejection head 8 to eject the predetermined target amount (e.g., 18 pl) of the standard ejection liquid (e.g., a standard ink, or a black ink).

In this case, the liquid ejection head 8 ejects the target amount of the standard ejection liquid when driven with the drive signal having the voltage adjusted, in step S1, to cause the liquid ejection head 8 to eject the reference amount (e.g., 17 pl) of the inspection liquid. In other words, in step S1, the voltage of the drive signal can be adjusted to cause the ejection amount of the standard ejection liquid (e.g., a standard ink, or a black ink) ejected from the liquid ejection head 8 to be the target amount (e.g., 18 pl).

Note that, in the present embodiment, the reference result used in step S1 is a result indicating the ejection amount of the inspection liquid being the predetermined reference amount. However, the reference result may not be determined with the ejection amount of the inspection liquid, but may be determined with, for example, the ejection speed of the inspection liquid ejected from the liquid ejection head 8, or other ejection results. Details of operation 3 and operation 4 may be changed accordingly.

### Details of Step S4

A method for correcting the adjusted voltage for the target head with the setter 902 (FIG. 6) in step S4 (FIG. 7) will now be described in detail.

In step S4, the setter 902 performs processing 1 to 3 described below.

In processing 1, the setter 902 obtains, from the storage 904, the correction value preliminarily associated with the position (e.g., right 1, rear 1) at which the target head (e.g., the pretreatment head 5) is mounted and the ejection liquid (e.g., the pretreatment liquid) to be ejected from the target head (e.g., the pretreatment head 5) that is the liquid ejection head 8 mounted in the opening 31H at the position.

The correction value obtained in processing 1 is determined as described below. FIG. 10 is a graph used to determine the correction value. A line G30 in FIG. 10 indicates the relationship between the voltage of the drive signal for the liquid ejection head 8 (the horizontal axis) and the ejection amount of the standard ejection liquid (e.g., a black ink) ejected from the liquid ejection head 8 driven with the drive signal having the corresponding voltage (the vertical axis). A line G31 in FIG. 10 indicates the relationship between the voltage of the drive signal for the liquid ejection head 8 (the horizontal axis) and the ejection amount of the ejection liquid (e.g., the pretreatment liquid) ejected from the liquid ejection head 8 driven with the drive signal having the corresponding voltage (the vertical axis). The lines G30 and G31 in FIG. 10 may be derived from experimental values.

More specifically, the correction value is determined, using the graph in FIG. 10, as a difference OFV between a voltage PV31 of the drive signal (e.g., 22.0 V) and a voltage PV30 of the drive signal (e.g., 24.1 V), where the voltage PV31 is a voltage for causing the liquid ejection head 8 to eject the target amount M0 (e.g., 18 pl) of the ejection liquid, and the voltage PV30 is a voltage for causing the liquid ejection head 8 to eject the target amount M0 of the standard ejection liquid (OFV=PV31−PV30; e.g., −2.1 V).

In processing 2 after processing 1, the setter 902 offsets, for correction, the voltage obtained by the obtainer 901 from the memory 84 in the target head in step S4 by adding the correction value obtained in processing 1 to the obtained voltage.

In processing 3, the setter 902 causes the storage 904 to store the voltage corrected in processing 2 in a manner associated with the identification information of the target head. This causes the setter 902 to set the voltage corrected in processing 2 as the voltage of the drive signal for the target head at the time of liquid ejection recording.

Note that the image former 903 (FIG. 6) obtains, at the time of liquid ejection recording, the voltage associated with the identification information of each of the target ink heads 4, the pretreatment head 5, and the post-treatment head 6 to be driven to form the image on the workpiece W, and drives each of the target ink heads 4, the pretreatment head 5, and the post-treatment head 6 with the drive signal having the obtained voltage.

Thus, when the voltage of the drive signal for the target head is adjusted in step S1 to cause the ejection amount of the standard ejection liquid (e.g., a standard ink, or a black ink) to be the predetermined target amount (e.g., 18 pl), the voltage of the drive signal for the target head adjusted in step S1 is offset by the difference between the voltage of the drive signal for causing the target head to eject the target amount (e.g., 18 pl) of the ejection liquid (e.g., the pretreatment liquid) and the adjusted voltage in step S4.

The voltage of the drive signal after offsetting is thus the voltage of the drive signal for causing the target head to eject the target amount (e.g. 18 pl) of the ejection liquid (e.g. the pretreatment liquid). Thus, the voltage of the drive signal for the target head at the time of liquid ejection recording is adjusted to the voltage of the drive signal for causing the liquid ejection head 8 to eject the predetermined target amount (e.g., 18 pl) of the ejection liquid (e.g., the pretreatment liquid).

When the ejection liquid to be ejected from the target head is the pretreatment liquid or the post-treatment liquid that develops no color, the drive signal during ejection of the ejection liquid cannot be adjusted using the density of the image actually formed with the ejection liquid unlike in step S1. However, the voltage of the drive signal during ejection of each of the same target amount of the standard ejection liquid, the pretreatment liquid, and the post-treatment liquid with the liquid ejection head 8 is measurable, and the relationship between the measured values is recordable at, for example, a laboratory. Thus, in the present embodiment, the voltage of the drive signal during ejection of the ejection liquid with the target head is corrected based on its relationship with the voltage of the drive signal during ejection of the standard ejection liquid, as described above.

Note that this correction method is applicable when the target head ejects, in addition to noncolor-developing treatment liquids, an ink (e.g., a yellow ink; hereafter referred to as a target ink) different from a standard ink (e.g., a black ink). In other words, the voltages of the drive signal during ejection of the same target amount of the standard ejection liquid and the target ink with the liquid ejection head 8 are measured. The voltage of the drive signal during ejection of the target ink can be corrected based on the relationship between the measured values, or its relationship with the voltage of the drive signal during ejection of the standard ejection liquid.

The ejection liquid to be ejected from the target head may be the standard ejection liquid (e.g., a black ink). In this case, the difference between the voltage of the drive signal for causing the target head to eject the target amount of the ejection liquid and the voltage of the drive signal for causing the target head to eject the target amount of the standard ejection liquid is zero. Thus, when the ejection liquid to be ejected from the target head is the standard ejection liquid, the correction value for correcting the voltage of the drive signal for the target head is zero. Thus, when the ejection liquid to be ejected from the target head is the standard ejection liquid, the correction of the adjusted voltage can be eliminated in step S4, reducing the time for the correction process.

Note that the correction value obtained in processing 1 and used in processing 2 is not limited to the above difference between the voltage of the drive signal for causing the liquid ejection head 8 to eject the target amount of the ejection liquid to be ejected from the target head and the voltage of the drive signal for causing the liquid ejection head 8 to eject the target amount of the standard ejection liquid.

For example, the correction value obtained in processing 1 and used in processing 2 may be determined as the ratio (e.g., PV31/PV30, or 22.0/24.1) of the voltage of the drive signal (e.g., PV31 in FIG. 10; 22.0 V) for causing the liquid ejection head 8 to eject the target amount (e.g., M0 in FIG. 10; 18 pl) of the ejection liquid to the voltage of the drive signal (e.g., PV30 in FIG. 10; 24.1 V) for causing the liquid ejection head 8 to eject the target amount of the standard ejection liquid. In this case, in processing 2, the voltage obtained by the obtainer 901 from the memory 84 in the target head may be multiplied by the correction value obtained in processing 1 to correct the voltage obtained from the memory 84 in the target head.

The correction value obtained in processing 1 and used in processing 2 may be the difference between the voltage of the drive signal for causing the liquid ejection head 8 to eject a predetermined amount, different from the target amount, of the ejection liquid to be ejected from the target head and the voltage of the drive signal for causing the liquid ejection head 8 to eject the target amount of the standard ejection liquid.

This correction value is determined as described below. FIG. 11 is a graph used to determine the correction value. A line G40 in FIG. 11 indicates the relationship between the voltage of the drive signal for the liquid ejection head 8 (the horizontal axis) and the ejection amount of the standard ejection liquid (e.g., a black ink) ejected from the liquid ejection head 8 driven with the drive signal having the corresponding voltage (the vertical axis). A line G41 in FIG. 11 indicates the relationship between the voltage of the drive signal for the liquid ejection head 8 (the horizontal axis) and the ejection amount of the ejection liquid (e.g., the post-treatment liquid) ejected from the liquid ejection head 8 driven with the drive signal having the corresponding voltage (the vertical axis). The lines G40 and G41 in FIG. 11 may be derived from experimental values.

More specifically, the correction value is determined, using the graph in FIG. 11, as the difference OFV between a voltage PV41 of the drive signal (e.g., 26.3 V) and a voltage PV40 of the drive signal (e.g., 24.1 V), where the voltage PV41 is a voltage for causing the liquid ejection head 8 to eject a predetermined amount (e.g., 9 pl), different from the target amount M0 (e.g., 18 pl), of the ejection liquid, and the voltage PV40 is a voltage for causing the liquid ejection head 8 to eject the target amount M0 of the standard ejection liquid (OFV=PV41−PV40; e.g., +2.2 V).

In this case, when the voltage of the drive signal for the target head is adjusted in step S1 (FIG. 7) to cause the ejection amount of the standard ejection liquid to be the predetermined target amount (e.g., 18 pl), the voltage of the drive signal for the target head adjusted in step S1 is offset by the difference between the voltage of the drive signal for causing the target head to eject a predetermined amount (e.g., 9 pl), different from the target amount, of the ejection liquid (e.g., the post-treatment liquid) and the adjusted voltage in step S4 (FIG. 7).

The voltage of the drive signal after offsetting is thus the voltage of the drive signal for causing the target head to eject a predetermined amount (e.g., 9 pl), different from the target amount, of the ejection liquid (e.g. the post-treatment liquid). Thus, the voltage of the drive signal for the target head at the time of liquid ejection recording is adjusted to the voltage of the drive signal for causing the liquid ejection head 8 to eject the predetermined amount (e.g., 9 pl), different from the target amount, of the ejection liquid (e.g., the post-treatment liquid).

In step S5 (FIG. 7), the setter 902 (FIG. 6) may set, as the waveform of the drive signal for the target head, a waveform based on the physical properties of the ejection liquid to be ejected from the target head, in addition to setting the drive voltage of the target head.

This structure can be achieved as described below, for example. The waveform based on the physical properties of the ejection liquid to be ejected from the liquid ejection head 8 can be predetermined based on results of experiments in which multiple liquids with different physical properties (e.g., different components, viscosity, or surface tension) are supplied to the liquid ejection head 8 and ejected. For example, the waveform of the drive signal for the liquid ejection head 8 can be determined based on the duration of applying the voltage to the piezoelectric element 81, the duration of interrupting the voltage applied to the piezoelectric element 81, and the number of times the application and interruption of the voltage for the piezoelectric element 81 are repeated in a single ejection cycle T of the drive signal for the liquid ejection head 8.

The storage 904 prestores, in a manner associated with each of the positions of the openings 31H (FIG. 3) in the head support frame 31 (FIG. 3) and the ejection liquid to be ejected from the liquid ejection head 8 mounted in the opening 31H at the position, the waveform of the ejection liquid predetermined based on its physical properties, in addition to the correction value for correcting the voltage of the drive signal for the liquid ejection head 8.

In this case, in step S5 (FIG. 7), the setter 902 obtains, from the storage 904, the waveform pre-associated with the position of the opening 31H in which the target head is mounted and with the ejection liquid to be ejected from the target head mounted in the opening 31H at the position.

The setter 902 then causes the storage 904 to store the waveform obtained from the storage 904 in a manner associated with the identification information of the target head. This causes the setter 902 to set the waveform obtained from the storage 904 as the waveform of the drive signal for the target head at the time of liquid ejection recording.

Note that the setter 902 may set the waveform of the drive signal for the target head at any time after step S3 (FIG. 7) and before image forming with the target head is performed, rather than in step S5 (FIG. 7).

This structure further allows each of the ink heads 4, the pretreatment head 5, and the post-treatment head 6 to eject an appropriate amount of liquid with the drive signal having the waveform based on the physical properties of the ejection liquid to be ejected from the corresponding one of the ink heads 4, the pretreatment head 5, and the post-treatment head 6.

Although the inkjet printer 1 according to an embodiment of the present disclosure is described above, the present disclosure is not limited to the above embodiment, and may be implemented in various manners as described below.

The functions of the controller 90 in the inkjet printer 1 may be partially or entirely implemented by, for example, a personal computer that transmits image information for printing to the inkjet printer 1. The inkjet printer 1 is not limited to an inkjet printer that ejects inks of multiple colors onto the workpiece W, and may eject an ink of a single color. The inkjet printer 1 may not include the pretreatment head 5 for ejecting the pretreatment liquid, the post-treatment head 6 for ejecting the post-treatment liquid, or any components associated with these heads.

In the above embodiment, the ink heads 4, the pretreatment head 5, and the post-treatment head 6 are the liquid ejection heads 8 that have undergone the adjustment process and thus have common specifications. However, the ink heads 4 alone may be the liquid ejection heads 8 that have undergone the adjustment process, and may have different specifications from the specifications of the pretreatment head 5 and the post-treatment head 6.

The multiple structures described in each of the above embodiments may be combined with one another to provide an embodiment of the present disclosure.

### REFERENCE SIGNS

1 inkjet printer (liquid ejection recording apparatus, image forming apparatus)
4 ink head (first liquid ejection head)
5 pretreatment head (second liquid ejection head)
6 post-treatment head (second liquid ejection head)
8 liquid ejection head
31H opening (mount, first mount, second mount)
81 piezoelectric element
82 liquid pressure chamber
83 nozzle
84 memory (storage)
901 obtainer
902 setter
903 image former
904 storage

1. A method for setting a drive signal, the method comprising:
adjusting a voltage of a drive signal for a liquid ejection head to an adjusted voltage to cause an ejection result of a predetermined inspection liquid ejected from the liquid ejection head to be a predetermined reference result, the liquid ejection head being configured to eject a liquid;
mounting, after adjusting the voltage, the liquid ejection head on a liquid ejection recording apparatus; and
correcting, after mounting the liquid ejection head, the adjusted voltage to a corrected voltage using a correction value associated with an ejection liquid to be ejected from the liquid ejection head.

2. The method according to claim 1, further comprising:
storing the adjusted voltage into a storage included in the liquid ejection head.

3. (canceled)

4. (canceled)

5. The method according to claim 1, wherein
the liquid ejection head includes a first liquid ejection head and a second liquid ejection head,
the ejection liquid includes an ink and a noncolor-developing treatment liquid, and
the first liquid ejection head mounted on the liquid ejection recording apparatus is configured to eject the ink, and the second liquid ejection head mounted on the liquid ejection recording apparatus is configured to eject the noncolor-developing treatment liquid.

6. The method according to claim 5, wherein
the noncolor-developing treatment liquid is a pretreatment liquid to be ejected before the ink.

7. The method according to claim 1, wherein
the inspection liquid is different from the ejection liquid.

8. The method according to claim 7, wherein
the inspection liquid is a first ink containing a dye.

9. The method according to claim 7, wherein
the ejection liquid is a second ink containing a pigment or a treatment liquid to fix the second ink on a recording medium.

10. The method according to claim 1, further comprising:
setting, after mounting the liquid ejection head, a waveform of the drive signal to a waveform based on physical properties of the ejection liquid.

11. The method according to claim 1, wherein
the reference result is a result indicating an ejection amount of the inspection liquid being a predetermined reference amount.

12. The method according to claim 11, wherein
adjusting the voltage includes determining the ejection result as the reference result when a density of an image formed with the inspection liquid ejected on a medium from the liquid ejection head ejecting matches a density of an image formed on the medium with the reference amount of the inspection liquid.

13. The method according to claim 11, wherein
in adjusting the voltage, the reference amount is the ejection amount of the inspection liquid ejected when the liquid ejection head is driven with a standard drive signal to cause the liquid ejection head to eject a predetermined target amount of a standard ejection liquid, and
in correcting the adjusted voltage, the correction value is a difference between a voltage of the drive signal to cause the liquid ejection head to eject the target amount of the ejection liquid and a voltage of the drive signal to cause the liquid ejection head to eject the target amount of the standard ejection liquid.

14. (canceled)

15. (canceled)

16. (canceled)

17. The method according to claim 13, wherein
the ejection liquid is the standard ejection liquid.

18. A liquid ejection head for ejecting a liquid, the liquid ejection head comprising:
a storage storing an adjusted voltage for a drive signal to cause the liquid ejection head to eject a predetermined inspection liquid to produce a predetermined reference result.

19. An image forming apparatus, comprising:
a liquid ejection head configured to eject a liquid, the liquid ejection head being drivable with a drive signal having a voltage adjusted to an adjusted voltage to cause an ejection result of a predetermined inspection liquid ejected from the liquid ejection head to be a predetermined reference result;
a mount on which the liquid ejection head is mountable;
a corrector configured to correct, for the drive signal for the liquid ejection head mounted on the mount, the adjusted voltage to a corrected voltage using a correction value associated with an ejection liquid to be ejected from the liquid ejection head; and
an image former configured to form an image on a recording medium with the ejection liquid ejected from the liquid ejection head driven with the corrected voltage.

20. The image forming apparatus according to claim 19, further comprising:
a storage storing the adjusted voltage,
wherein the corrector obtains the adjusted voltage from the storage.

21. The image forming apparatus according to claim 20, wherein
the storage is in the liquid ejection head.

22. The image forming apparatus according to claim 19, wherein
the corrector obtains the adjusted voltage from a storage storing the adjusted voltage and external to the image forming apparatus.

23. (canceled)
